(19) United States
(12) Patent Application Publication
(10) Pub. No.: US 2009/0140457 A1
(43) Pub. Date: Jun. 4, 2009

(54) APPARATUS AND METHOD FOR IN-MOLD-DECORATION

(75) Inventor: CHUN-YUAN CHANG, Tu-Cheng (TW)

Correspondence Address: PCE INDUSTRY, INC.;ATT. Steven Reiss, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/965,755

(22) Filed: Dec. 28, 2007

(30) Foreign Application Priority Data
Dec. 4, 2007 (CN) 200710202835.5

(51) Int. Cl. B29C 45/16

(52) U.S. Cl. 264/269; 425/116

(57) ABSTRACT

An apparatus for in-mold-decoration includes a mold, a foil, and a press member. The mold includes a female mold and a male mold with a protrusion protruding therefrom towards the female mold. The foil is applied to a surface of the female mold facing the male mold and corresponding to a surface of a molded product to be decorated. The press member is positioned between the male mold and the female mold and the foil is further extended to be on a surface of the press member to be urged thereby to cover an end of the molding space as the press member is positioned to cooperate with the male and female molds to define a molding space thereamong, thereby ensuring the foil with a printed layer thereon completely and uniformly covers the surface of the molded product to be decorated, even unto its very edges.

### CROSS-REFERENCE TO RELATED APPLICATIONS

Relevant subject matter is disclosed in a co-pending U.S. Patent Application (Attorney Docket No. US16717) filed on the same date and entitled “APPARATUS FOR IN-MOLD-DECORATION MOLDING”, which is assigned to the same assignee with this application.

### BACKGROUND

1. Field of the Invention

The present invention generally relates to molding apparatuses and methods. Particularly, the present invention relates to an apparatus and a relative method for in-mold-decoration.

2. Description of Related Art

A common apparatus for In-Mold-Decoration is illustrated in FIG. 1. The apparatus includes a mold 20 defining a cavity (not labeled) therein and a foil 30. The mold 20 includes a male mold 22 and a female mold 24. The male mold 22 and the female mold 24 cooperate to define a molding space 10 therein. The foil 30 is extended in the mold 20 between the male mold 22 and the female mold 24, and is spread on a surface of the cavity. A printed layer 32 is attached to the foil 30 facing the male mold 22. The printed layer 32 is positioned in the molding space 10 for providing decoration for a molded product.

Referring to FIG. 2, the molding space 10 is filled with molten resin to form a molded product 40. The printed layer 32 is attached to a surface of the molded product 40 after the molten resin is cooled, therefore providing decoration for the molded product 40. However, usually not all of the printed layer 32 is attached to the molded product 40, due to the fact that the foil 30 together with the printed layer 32 cannot always be pressed against the entire surface of the molded product 40 to be decorated by the inner surface of the molding space 10, especially the part adjacent to a parting surface of female mold 24 where an edge near a collar of the molded product 40 is formed. Therefore, a part of the printed layer 32 may be still preserved on the foil 30.

### SUMMARY

In one embodiment, an apparatus for in-mold-decoration includes a mold, a foil, and a press member. The mold includes a female mold and a male mold with a protrusion protruding therefrom towards the female mold. The foil is applied to a surface of the female mold facing the male mold and corresponding to a surface of a molded product to be decorated. The press member is positioned between the male mold and the female mold and the foil is further extended to be on a surface of the press member to be urged thereby to cover an end of the molding space as the press member is positioned to cooperate with the male and female molds to define a molding space thereamong, thereby ensuring the foil with a printed layer thereon completely and uniformly covers the surface of the molded product to be decorated, even unto its very edges.

Other advantages and novel features of the apparatus and method for in-mold-decoration will become more apparent from the following detailed description of embodiments when taken in conjunction with the accompanying drawings, in which:

### BRIEF DESCRIPTION OF THE DRAWINGS

FIG. 1 is a sectional view of an apparatus for in-mold-decoration in a related art;

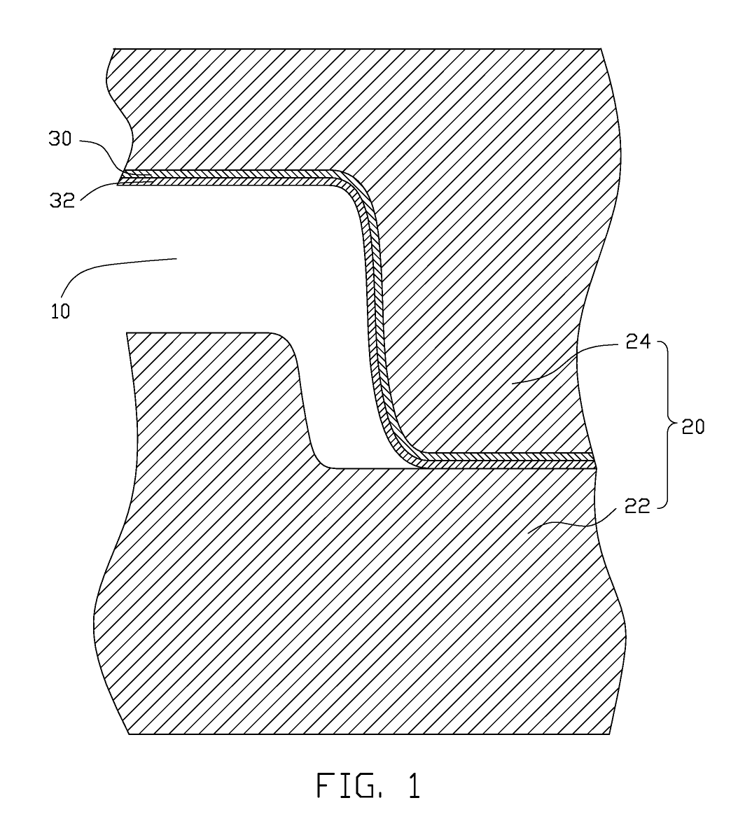

FIG. 2 is a sectional view of the apparatus of FIG. 1 during injection;

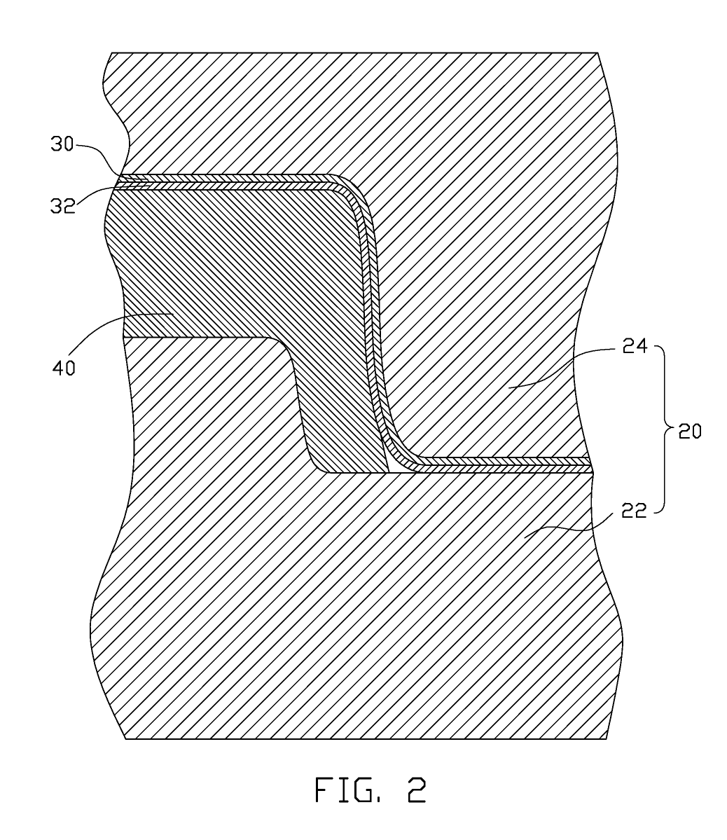

FIG. 3 is a sectional view of an apparatus for in-mold-decoration in accordance with a first embodiment;

FIG. 4 is a sectional view of the apparatus of FIG. 3 during injection;

FIG. 5 is a sectional view of an apparatus for in-mold-decoration in accordance with a second embodiment during injection;

FIG. 6 is a sectional view of an apparatus for in-mold-decoration in accordance with a third embodiment; and

FIG. 7 is a sectional view of the apparatus of FIG. 6 during injection.

### DETAILED DESCRIPTION

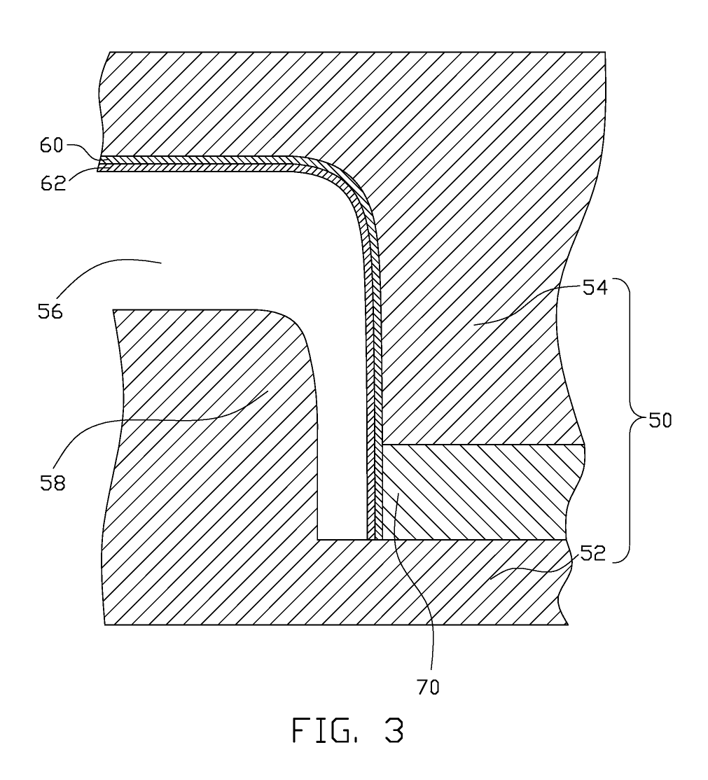

Referring to FIG. 3, an apparatus for in-mold-decoration in accordance with a first embodiment of the present invention includes a mold 50, a foil 60, and a press member 70.

The mold 50 includes a male mold 52 and a female mold 54. A cavity (not labeled) is defined in the female mold 54 facing the male mold 52. The male mold 52 protrudes towards the female mold 54 to form a protrusion 58. The male mold 52 and the female mold 54 generally cooperating to define a molding space 56 in the mold 50, but leaving a space at an end of the molding space 56 for the press member 70.

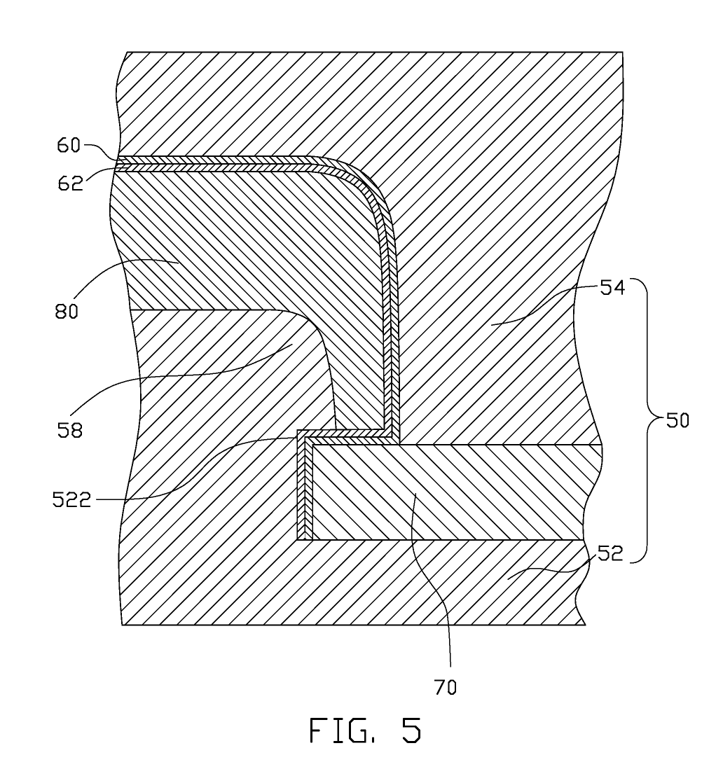

The foil 60 is extended in the molding space 56 and spread on a surface thereof. A printed layer 62 is attached to the foil 60 at a side thereof facing the male mold 52 and corresponding to a surface of a molded product 80 (as shown in FIG. 5) to be decorated.

The press member 70 is movably positioned between the female mold 54 and the male mold 52, with a first side thereof contacting with a parting surface of the female mold 54 and a second side thereof opposite the first side contacting with a parting surface of the male mold 52. An end surface connected between the first and second sides of the press member 70 faces the protrusion 58 of the male mold 52. The foil 60 is also spread on the end surface of the press member 70.

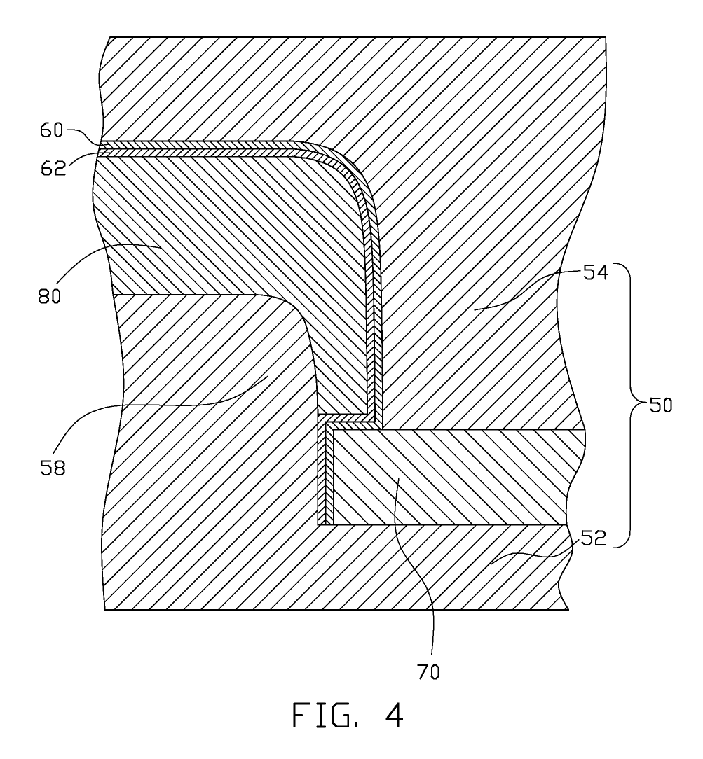

Referring to FIG. 4, the foil 60, together with the printed layer 62, is transported into the mold 50, between the male mold 52 and the female mold 54. The foil 60 is attached to the surface of the cavity of the female mold 54 and the end surface of the press member 70. The press member 70 is driven to move towards the protrusion 58 of the male mold 52, until firmly sandwiching the foil 60 together with the protrusion 58 of the male mold 52. The foil 60, together with the printed layer 62 is spread on the first side of the press member 70, and covers the end of the molding space 56. Molten resin is injected into the molding space 56, and cooled down to form a molded product 80. As the foil 60 covers the end of the molding space 56, the printed layer 62 is able to be attached to an edge near a collar of the molded product 80. After the molded product 80 is ejected from the mold 50, the foil 60 and the printed layer 62 are attached to an outer surface of the molded product 80 to provide an integrated decoration.

Referring to FIG. 5, an apparatus for in-mold-decoration in accordance with a second embodiment is generally similar to that of FIG. 3. The differences are that the protrusion 58 of the male mold 52 further defines a depressed portion 522 therein relative to the end of the press member 70, for receiving a distal end of the press member 70. Therefore, the foil 60, along with the printed layer 62 can be driven by the press member 70 to attach to an inner surface of the depressed portion 522. The foil 60 and the printed layer 62 are able to cover the end of the molding space 56. Therefore, the edge of the molded product 80 can also be covered by the printed layer 62.

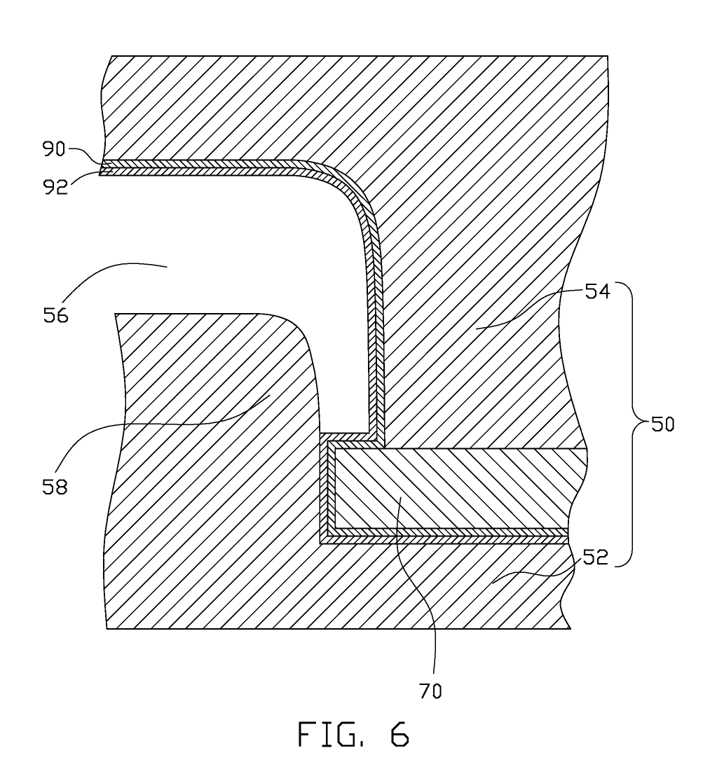

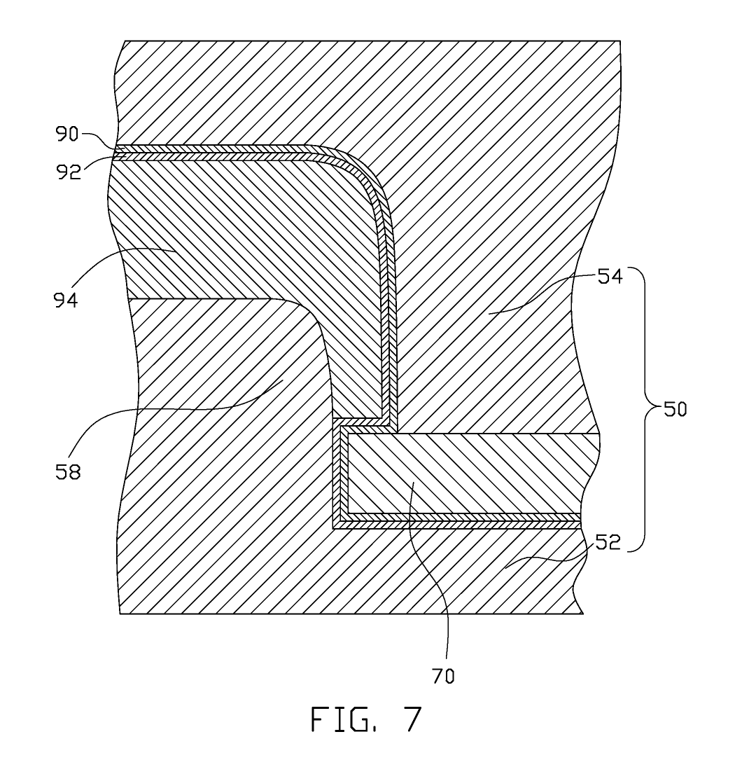

Referring to FIGS. 6 and 7, an apparatus for in-mold-decoration in accordance with a third exemplary embodiment is generally similar to FIG. 3. The differences are that a foil 90 with a printed layer 92 thereon is further extended along the second side of the press member 70.

The embodiments were chosen and described in order to explain the principles of the invention and their practical application so as to enable others skilled in the art to utilize the invention and various embodiments and with various modifications as are suited to the particular use contemplated. Alternative embodiments will become apparent to those skilled in the art to which the present invention pertains without departing from its spirit and scope. Accordingly, the scope of the present invention is defined by the appended claims rather than the foregoing description and the exemplary embodiments described therein.

1. An apparatus for in-mold-decoration comprising:
a mold comprising a female mold and a male mold with a protrusion protruding therefrom towards the female mold;
a foil applied to a surface of the female mold facing the male mold and corresponding to a surface of a molded product to be decorated; and
a press member positioned between the male mold and the female mold, wherein
the foil is further extended to be on a surface of the press member to be urged thereby to cover an end of the molding space as the press member is positioned to cooperate with the male and female molds to define a molding space thereamong.

2. The apparatus as described in claim 1, wherein a depressed portion is defined in the protrusion relative to the press member, for receiving a corresponding end of the press member as the press member moves to the protrusion.

3. The apparatus as described in claim 2, wherein the foil is spread on an inner surface of the depressed portion as the press member is received in the depressed portion.

4. The apparatus as described in claim 1, wherein the foil is sandwiched between the press member and the protrusion of the male mold.

5. The apparatus as described in claim 4, wherein a printed layer is provided on the foil facing the male mold, the printed layer is configured for being attached to the molded product.

6. An apparatus for in-mold-decoration comprising:
a female mold and a male mold for being locked together, a protrusion protruding from the male mold towards the female mold; and
a press member movably positioned between the female mold and the male mold, for cooperatively defining a molding space together with the male mold and the female mold, the press member being configured for pressing a foil to against edges of a surface to be decorated.

7. The apparatus as described in claim 6, wherein a surface of the molding space and an end surface of the press member configured for allowing the foil spreading thereon.

8. The apparatus as described in claim 6, wherein a depressed portion is defined in the protrusion, for receiving a corresponding end of the press member.

9. The apparatus as described in claim 6, wherein the press member is sandwiched between the male mold and the female mold, to be movable toward the protrusion of the male mold.

10. (canceled)

11. (canceled)
